(19) United States
(12) Patent Application Publication
(10) Pub. No.: US 2019/0388291 A1
(43) Pub. Date: Dec. 26, 2019

(54) INCUBATOR

(71) Applicant: ATOM MEDICAL CORPORATION, Bunkyo-ku, Tokyo (JP)

(72) Inventors: Keisuke WAKABAYASHI, Saitama City, Saitama (JP); Yasuyuki YAMAME, Saitama City, Saitama (JP); Ichiro MATSUBARA, Bunkyo-ku, Tokyo (JP)

(21) Appl. No.: 16/481,757

(22) PCT Filed: Jan. 29, 2018
(86) PCT No.: PCT/JP2018/002677

§ 371 Date: Jul. 29, 2019

(30) Foreign Application Priority Data
Jan. 30, 2017 (JP) 2017-014242

(51) Int. Cl. A61G 11/00

(52) U.S. Cl. CPC A61G 11/00; A61G 2203/20; A61G 2203/16

(57) ABSTRACT

An incubator includes an operation unit that enables an operator to operate a plurality of medical devices, a control unit, and a display unit capable of displaying each operation status of the medical devices and patient information. The operation unit includes a first operation unit which is operable by using a location other than a hand of the operator. The control unit includes selection means for selecting an operation of the medical device and allocating the medical device to the first operation unit, and execution means for executing the operation of the selected medical device. The selection means includes selection screen display means for causing the display unit to display a selection screen for allocating the operation of the medical device to the first operation unit, operation switching means for switching the operation of the medical device allocated to the first operation unit, when the first operation unit is repeatedly operated within a selected operation time, and operation confirmation means for confirming the selection of the medical device, when the first operation unit is operated beyond the selected operation time in a state where any one operation of the medical devices is allocated to the first operation unit.

### RELATED APPLICATIONS

This application is a 371 application of PCT/JP2018/002677 having an international filing date of Jan. 29, 2018, which claims priority to Japanese Patent Application No. 2017-14242, filed on Jan. 30, 2017, the entire content of each of which is incorporated herein by reference.

### BACKGROUND OF THE INVENTION

### 1. Field of the Invention

The present invention relates to incubators such as an open-type incubator, a closed-type incubator, and a baby resuscitation incubator which are used for medical treatment of a patient such as the newborn baby.

### 2. Description of the Related Art

In order to perform suitable medical examination or medical treatment for a patient such as a newborn baby under a suitable environment, a general incubator includes various medical devices such as an air heater for warming the patient, a timer for counting a resuscitation period and an evaluation period for the patient, and a sensor for measuring respiratory rates or heartbeats of the patient. Then, in order that the incubator enables an operator (medical worker) such as a doctor or a nurse to easily recognize information relating to an operation of the medical devices or conditions of the patient, a display unit for displaying the information and an operation unit for controlling each device are respectively arranged at positions which are easily visible to the operator.

For example, PTL 1 discloses an open-type incubator (infant warmer) having a timer incorporated for newborn baby resuscitation. On a front side surface of an upper support pillar connecting a rear end portion of a bed base and a canopy to each other, control and display units having a control function and a display function are arrayed so as to be adjacent to the canopy.

In addition, PTL 2 discloses an incubator having an enclosure capable of accommodating a baby. The incubator includes a display unit which can display information on an incubating environment inside the enclosure, an attachment location to which the display unit can be attached, and an attachment mechanism which can attach the display unit to the attachment location. Then, PTL 2 discloses the following. The attachment mechanism includes suction-type suction means. An operator can easily understand the information on the incubating environment inside the enclosure by attaching the display unit to an easily visible location (for example, an outer surface of a top plate portion of a top surface hood of the enclosure). Furthermore, the operator can change or switch operating conditions of the incubator by operating an operation unit of the display unit.

### 3. Prior Art Documents

### Patent Literature

Patent Document 1: Japanese Unexamined Patent Application, First Publication No. 2009-45305

Patent Document 2: Japanese Unexamined Patent Application, First Publication No. 2013-233335

### SUMMARY OF THE INVENTION

### Technical Problem

As disclosed in Patent Document 1 or Patent Document 2, the display unit and the operation unit of the incubator are arranged at the easily visible location to the operator, that is, at a relatively high position of the incubator. Accordingly, the operator has to operate the operation unit by using a hand of the operator. Therefore, the operator such as the doctor cannot operate the operation unit in a state where both hands are closed during medical treatment of the patient. The operator needs to interrupt the medical treatment, or a person other than the operator (doctor) who performs the medical treatment needs to assist the operation of the operation unit. In addition, in a case where the operator himself or herself such as the doctor interrupts the medical treatment and operates the operation unit, the hand of the operator directly touches the operation unit in a contaminated state. Consequently, there is a possibility of cross infection that the patient may be infected via the operation unit and the hand of the operator, thereby causing a problem in terms of hygiene.

The present invention is made in view of the above-described circumstances, and the operator can easily operate the medical aims to provide an incubator which enables an operator to easily operate various medical devices included in the incubator even during medical treatment, and which can minimize a cross infection risk of a patient.

### Solution to Problem

According to the present invention, there is provided an incubator including an operation unit that enables an operator to operate a plurality of medical devices, a control unit that manages the medical devices and the operation unit, and a display unit capable of displaying each operation status of the medical devices and patient information. The operation unit includes a first operation unit which is operable by using a location other than a hand of the operator. The control unit includes selection means for selecting an operation of any one medical device from the plurality of medical devices so as to allocate the medical device to the first operation unit, and execution means for executing an operation of the medical device allocated to the first operation unit. The selection means includes selection screen display means for causing the display unit to display a selection screen for allocating any operation of the plurality of medical devices to the first operation unit, operation switching means for switching the operation of the medical device allocated to the first operation unit, when the first operation unit is repeatedly operated within a selected operation time subsequently to the display of the selection screen, and operation confirmation means for confirming the selection of the medical device allocated at an operation time thereof, when the first operation unit is operated beyond the selected operation time in a state where any one operation of the medical devices is allocated to the first operation unit. The execution means executes the operation of the medical device selected at an operation time thereof, when the first operation unit is operated in a state where the selection of the medical device is confirmed.

According to the incubator of the present invention, as the operation unit for operating the medical device, there is provided the first operation unit which is operable by using the location other than the hand of the operator, for example, a foot, a knee, or an elbow of the operator. Accordingly, the operator can operate various medical devices without interrupting medical treatment (while continuously performing the medical treatment). In addition, the operator can select various medical devices by operating the first operation unit itself so as to perform an operation thereof. Without using both hands, that is, without touching the first operation unit, the first operation unit enables the operator to operate various medical devices. Accordingly, it is possible to prevent cross infection to a patient which is caused by operations thereof. Furthermore, each operation of the plurality of medical devices is allocated to the first operation unit disposed in one location. Therefore, it is not necessary to dispose a plurality of operation units for each of the medical devices, and thus, a configuration of the incubator can be simplified. In addition, each of the medical devices can be operated only by operating the first operation unit disposed in one location. Therefore, the operator can easily operate the medical devices.

For example, operation information may adopt any one of an operation time length of the first operation unit itself which performs the operation of the respective medical devices, the number of operations, and a difference in operation positions. However, the selection means and the execution means can be controlled, based on operation time information of the first operation unit itself. In this manner, compared to a case where the selection means and the execution means are controlled using other information on the number of operations or operation position information, the operator can easily operate various medical device.

For example, in a case where the operator can operate the medical devices by stepping on the first operation unit and the medical devices are controlled using the information on the number of operations performed on the first operation unit, the operator needs to repeatedly step on the first operation unit. Accordingly, the operation is complicated, thereby causing a possibility that an error may occur in the number of inputting times. In addition, in a case where the medical devices are controlled using operation position information for the first operation unit (for example, information on a position to be stepped by a foot), the operator needs to visually confirm the position to be stepped on in the first operation unit. Consequently, the operation is inconvenient, and it is necessary to arrange a plurality of detection switches in the first operation unit, thereby increasing production cost in some cases. In this regard, the medical devices are controlled using the operation time information. In this manner, it is possible to avoid the complicated operation or the inconvenient operation as in a case where the medical devices are controlled using the information on the number of operations or the operation position information.

In addition, the operator can easily and visually recognize the operation status of the medical device and the patient information by using the display unit. Accordingly, even the first operation unit is operated using the location other than the hand, the operator can easily operate the medical device while accurately recognizing the operation status of the medical device and the patient information. In addition, the medical device allocated to the first operation unit can be easily confirmed in the display unit by the operator. Therefore, it is possible to avoid a risk such as an operation error.

In this case, the selection screen display means may cause the display unit to display the selection screen, when the first operation unit is operated within the selected operation time.

In the incubator according to the present invention, the first operation unit may be a pedal operation unit which is operable by using a foot of the operator.

The pedal operation unit which is operable by using the foot away from the hand is adopted as the first operation unit, and the first operation unit is operable by using the foot. In this manner, compared to a case where the first operation unit is operated by using an elbow close to the hand, the movement of both hands of the operator during the operation of the first operation unit can be less affected. Therefore, the operator can easily and reliably operate various medical devices even during the medical treatment.

In the incubator according to the present invention, the operation unit may include a second operation unit which is operable by using the hand of the operator. In addition, the second operation unit may be located together with the display unit, or may be located adjacent to the display unit.

In addition to the first operation unit which is operable by using the location other than the hand of the operator, a configuration is adopted which includes the second operation unit which is operable by using the hand of the operator, similarly to the incubator in the related art as disclosed in PTL 1 or PTL 2. In this manner, the incubator can be operated using means the same as that in the related art.

In this case, the second operation unit is configured to be shared with a touch panel-type display unit. In this manner, the second operation unit can be shared with the display unit. An operation button is located at a position closely adjacent to the display unit. In this manner, the second operation unit can be individually used.

### Advantageous Effects of Invention

According to the present invention, an operator such as a doctor can easily operate various medical devices even during medical treatment without directly touching an operation unit. Therefore, it is possible to prevent cross infection caused by the operation.

### BRIEF DESCRIPTION OF THE DRAWINGS

FIG. 1 is a perspective view of an open-type incubator illustrating an embodiment of the present invention.

FIG. 2 is a hardware block diagram of the open-type incubator illustrated in FIG. 1.

FIG. 3 is a front view of an idle screen serving as an initial display screen of a display unit of the open-type incubator illustrated in FIG. 1.

FIG. 4 is a front view of a display screen of the display unit which displays a selection screen, and illustrates a state where a raising-lowering operation switch of raising-lowering means is selected.

FIGS. 5A-5D are front views of the selection screen. FIG. 5A illustrates the selection screen on which the raising-lowering operation switch of the raising-lowering means is selected; FIG. 5B illustrates the selection screen on which a counting start switch of a resuscitation timer is selected; FIG. 5C illustrates the selection screen on which an alarm sound stop switch is selected; and FIG. 5D illustrates the selection screen on which an on/off switch of a lighting lamp is selected.

FIG. 6 is a front view of the display screen of the display unit which displays a confirmation screen.

FIGS. 7A-7D are front view of the confirmation screen. FIG. 7A illustrates the confirmation screen which selects the raising-lowering operation switch of the raising-lowering means; FIG. 7B illustrates the confirmation screen which selects the counting start switch of the resuscitation timer; FIG. 7C illustrates the confirmation screen which selects the alarm sound stop switch; and of FIG. 7D illustrates the confirmation screen which select the on/off switch of the lighting lamp.

FIG. 8 is a flowchart of a first operation unit of the open-type incubator illustrated in FIG. 1.

FIG. 9 is each functional block diagram of an operation unit and a control unit in the hardware block diagram illustrated in FIG. 2.

### DETAILED DESCRIPTION OF THE PREFERRED EMBODIMENTS

Hereinafter, an embodiment in which the present invention is applied to an open-type incubator (so-called infant warmer) will be described.

### [Overall Configuration of Incubator]

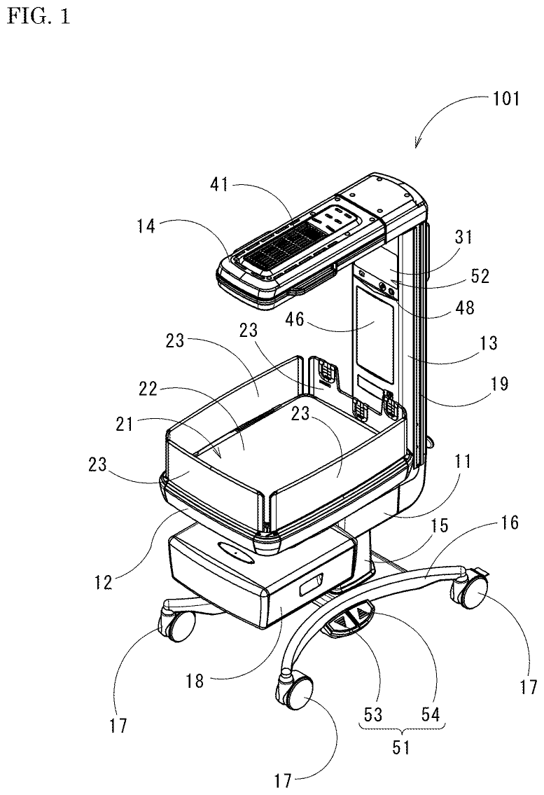

As generally illustrated in FIG. 1, an incubator (open-type incubator) 101 according to the present embodiment includes a leg portion 16 which is movable by a caster 17, a lower side support pillar 15 (hereinafter, referred to as a lower support pillar) which is erected on the leg portion 16, a base 11 which is fixed to an upper end portion of the lower support pillar 15, a bed base 12 attached onto the base 11, an upper side support pillar 13 (hereinafter, referred to as an upper support pillar) which is erected on the base 11, and a canopy 14 which is cantilevered by an upper end portion of the upper support pillar 13. In addition, as illustrated in FIG. 1, the base 11 of the incubator 101 has an accommodation case 18 which can accommodate equipment. Each attachment rail 19 which can be used when attaching various articles (not illustrated) is fixed to both right and left side surfaces of the upper support pillar 13.

The lower support pillar 15 of the incubator 101 is configured to include raising-lowering means. The base 11, and the bed base 12, the upper support pillar 13, the canopy 14, and the accommodation case 18 which are arranged on the base 11 are disposed so as to be raised and lowered with respect to the leg portion 16. Hereinafter, the lower support pillar and the raising-lowering means are represented by the common reference numeral 15. The raising-lowering means 15 is not particularly limited, and various driving means such as electric actuators can be used.

A bed portion 21 which enables a patient such as a newborn baby to sleep (lie down) is configured to be located on the bed base 12. A mat 22 is located in the bed portion 21. In addition, the bed portion 21 of the bed base 12 has a falling prevention plate 23 for preventing the patient lying on the mat 22 from falling out of the bed portion 21. Four sheets of the falling prevention plate 23 are arrayed so as to surround the mat 22 on the bed portion 21 in all directions.

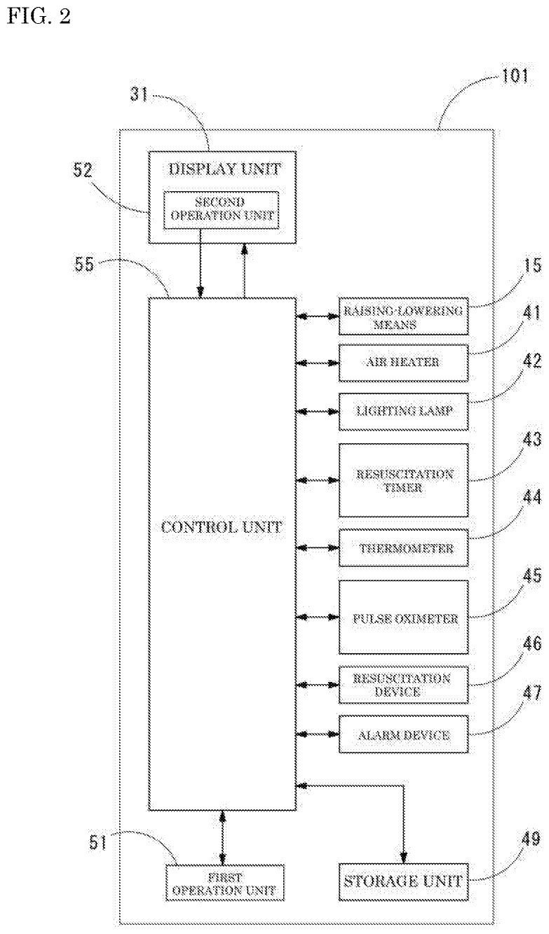

The canopy 14 is internally equipped with an air heater (heater) 41 which is located to face an upper surface of the bed portion 21 and which can emit heat rays to an upper surface of the mat 22, and a lighting lamp 42 (refer to FIG. 2) which illuminates the upper surface of the mat 22.

In addition, as illustrated by the hardware block diagram in FIG. 2, in addition to the raising-lowering means 15, the air heater 41, and the lighting lamp 42 which are described above, the incubator 101 includes various medical devices such as a resuscitation timer 43, a thermometer 44 which measures a body temperature of a patient by a body temperature probe, a pulse oximeter 45 which measures a pulse rate and SPO2 (blood oxygen saturation), a resuscitation device 46 which has an oxygen blender or a manometer, and an alarm device 47 which issues alarm sound. The resuscitation device 46 is located in a lower side portion on a front side surface of the upper support pillar 13 at a position close to the bed portion 21.

In addition, as illustrated by the hardware block diagram in FIG. 2, the incubator 101 includes a display unit 31 which can display an operation status of the above-described medical devices 15 and 41 to 47 and patient information, and operation units 51 and 52 which enables the operator to operate the medical devices. Furthermore, the incubator 101 is internally equipped with a control unit 55 (computer) for managing the display unit 31, the operation units 51 and 52, and various medical devices 15 and 41 to 47. The control unit 55 is configured to include a computer, and includes an input unit, an output unit, a calculation unit (CPU), and a main storage device. Then, the control unit 55 is configured to receive a signal from the operation units 51 and 52 connected to the input unit so as to control the display unit 31 connected to the output unit and various medical devices 15 and 41 to 47. In addition, the control unit 55 includes a storage unit (external storage device) 49 which stores various items of control data.

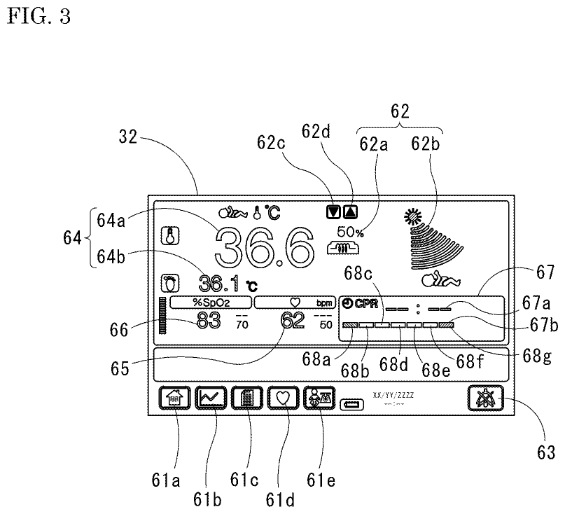

As illustrated in FIG. 1, the display unit 31 is attached to the upper side portion of the front side surface of the upper support pillar 13, and is located at a position which is easily visible to the operator who stands in front of the incubator 101, for example. As described above, the incubator 101 includes the thermometer 44 which measures the body temperature of the patient, the pulse oximeter 45 which measures the pulse rate and SPO2. For example, as illustrated in FIG. 3, the display unit 31 has a patient body temperature display unit 64 which displays the above-described data, a heart rate display unit 65, and an SPO2 display unit 66. The upper support pillar 13 includes a power switch 48 which turns on and off power of the incubator 101 at an easily visible position on the lower side of the display unit 31.

In addition, as the operation unit 50, the incubator 101 has a first operation unit 51 which can be operated by using a location other than the hand of the operator, and a second operation unit 52 which can be operated by using the hand of the operator.

As illustrated in FIG. 1, the incubator 101 has a pair of front and rear pedal operation units 53 and 54 located in the leg portion 16 away from the display unit 31, that is, at positions which are easily operable by using the foot of the operator. The pedal operation units 53 and 54 serve as the first operation unit 51 according to the present invention. Although the illustration is omitted, the incubator 101 has the pair of pedal operation units 53 and 54 (first operation unit 51) respectively on the right side and the left side. Common operations can be performed from any right or left side of the incubator 101.

In addition, in the incubator 101, the display unit 31 is configured to include a touch panel-type monitor provided with both a display function and an input function. The display unit 31 functions as the second operation unit 52 in addition to the display function. Therefore, in the incubator 101, the pedal operation units 53 and 54 (first operation unit 51) are operated, or an operation switch displayed on the display unit 31 (second operation unit 52) is operated (pressed) so as to perform an input operation on various medical devices.

Instead of using the display unit 31 as the second operation unit 52, an individual operation units (second operation units) can be located at a position closely adjacent to the display unit 31. In this case, the second operation unit 52 is located at a relatively high position (upper side of the upper support pillar 13) of the incubator 101. Accordingly, the second operation unit 52 needs to be operated by using the hand. However, the second operation unit 52 is located together with the display unit 31, or adjacent to the display unit 31. Therefore, the operator can operate the second operation unit 52 while easily confirming the display unit 31.

### [Operation of Incubator]

Next, an operation of the incubator 101 will be described.

First, the power switch 48 of the incubator 101 is turned on. If the power switch 48 is turned on, the control unit 55 performs a self-check so as to check whether each connection state of various medical devices such as the thermometer 44 is normal. In a case where the self-check is normally completed, the incubator 101 starts to be operated. As illustrated in FIG. 3, an idle screen 32 serving as an initial display screen is displayed on the display unit 31.

The display unit 31 can switch and display a plurality of display screens in addition to the idle screen 32. In addition, the display unit 31 of the incubator 101 is configured to include the touch panel-type monitor as described above. Accordingly, for example, switching operation switches 61a to 61e included in a lower left portion of the idle screen 32 illustrated in FIG. 3 are pressed. In this manner, the idle screen 32 serving as the initial screen can be switched to another display screen.

The idle screen 32 in FIG. 3 displays various pieces of information such as an environment of the incubator 101 and the patient information, and displays operation switches for operating various medical devices. For example, the reference numeral 62 represents a heater output display unit which displays a desired output value with respect to a maximum output (rated output) of the air heater 41. The heater output display unit 62 has a numerical value display unit 62a which numerically displays the desired output value (%), and a stage (level) display unit 62b which graphically displays the output value. In addition, output change switches 62c and 62d for changing the output of the air heater 41 are disposed close to the numerical value display unit 62a. The output of the air heater 41 can be increased and decreased by pressing the output change switches 62c and 62d. The output change switch 62c on the left side serves as a decreasing switch, and the output change switch 62d on the right side serves as an increasing switch.

In addition, the reference numeral 63 represents an alarm sound stop switch of the alarm device 47. The alarm sound can be stopped by pressing the alarm sound stop switch 63 while the alarm sound is issued. In addition, as described above, the incubator 101 includes the thermometer 44 and the pulse oximeter 45. The idle screen 32 of the display unit 31 has the patient body temperature display unit 64 for displaying the above-described data, the heart rate display unit 65, and the SPO2 display unit 66. The body temperature display unit 64 has two units such as a trunk temperature display unit 64a and a foot temperature display unit 64b. The trunk temperature display unit 64a is configured to display a body temperature of a trunk of the patient, and the foot temperature display unit 64b is configured to display a foot temperature of the patient.

In addition, the reference numeral 67 represents a timer display unit of the resuscitation timer 43. The timer display unit 67 includes an elapsed time display unit 67a which numerically displays a total elapsed time and a second point display unit 67b for displaying every one second by sequentially lighting 0 to 6. The elapsed time display unit 67a is configured to be capable of displaying four digit numbers. The timer display unit 67 of the idle screen 32 also serves as a counting start switch for causing the elapsed time display unit 67a to start counting. In a state where the counting of the resuscitation timer 43 is turned off, a display region of the timer display unit 67 is pressed (touched). In this manner, the counting of the elapsed time can start. In addition, if the display region of the timer display unit 67 is pressed and operated one more time (again) during the counting, the counting of the elapsed time can be completed, and the resuscitation timer 43 incorporated in the incubator 101 is reset.

The resuscitation timer 43 is generally operated at the birth of a newborn baby, and the elapsed time display unit 67a displays the elapsed time from the birth of the newborn baby in units of minutes and seconds. In FIG. 3, the elapsed time display unit 67a is configured to display the elapsed time in units of hours and minutes, but may be configured to display the elapsed time in units of hours, minutes, and seconds.

The second point display unit 67b, displays a newborn baby evaluation period to be provided between two newborn baby resuscitation times. The second point display unit 67b includes seven point indicators 68a to 68g from the 0-th point indicator 68a in the left end to the 6-th point indicator 68g in the right end. The second point display unit 67b is configured to sequentially light the indicators at an interval of 1 second from a starting time point to a completion time point of a newborn baby evaluation period of 6 seconds.

In this way, in the incubator 101, various operation switches displayed on the display screen of the display unit 31 (in the above description, the alarm sound stop switch 63 and the timer display unit 67, and both of these serve as the second operation unit 52) are operated so as to enable the input operation on various medical devices included in the incubator 101. On the other hand, as described above, the incubator 101 includes the pedal operation units 53 and 54 (first operation unit 51). The pedal operation units 53 and 54 are operated so as to enable the input operation on various medical devices included in the incubator 101.

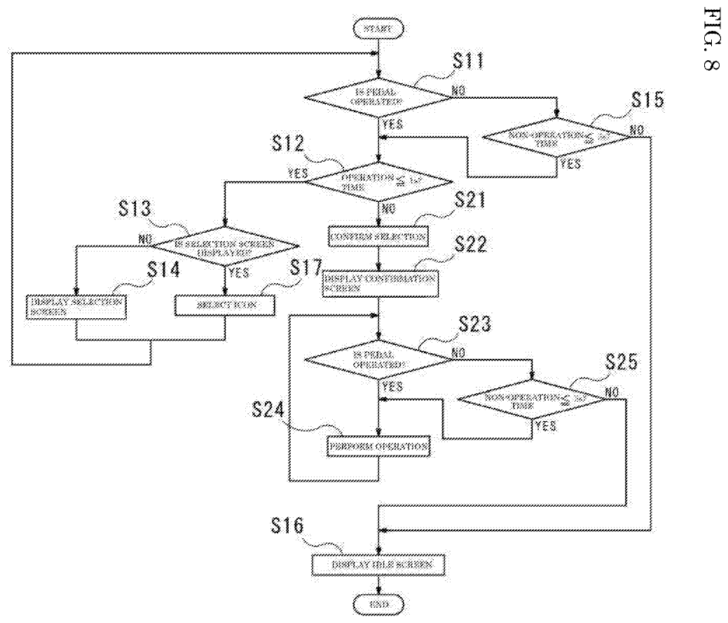

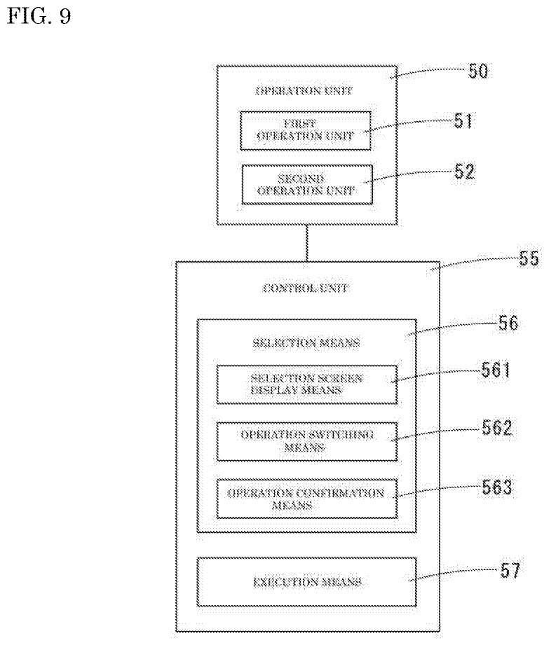

An operation of the incubator 101 which is performed by the first operation unit 51 will be described with reference to display screens of the display unit 31 illustrated in FIGS. 3 to 7, a flowchart of the first operation unit 51 illustrated in FIG. 8, and a functional block diagram illustrated in FIG. 9.

In the incubator 101, the pedal operation units 53 and 54 (first operation unit 51) can be used as a raising-lowering operation switch of the raising-lowering means 15, a counting start switch of the resuscitation timer 43, an alarm sound stop switch of the alarm device 47, and an on/off switch of the lighting lamp 42 for the plurality of medical devices 15 and 41 to 47. Then, the control unit 55 of the incubator 101 includes selection means 56 for selecting an operation of any one medical device from the medical devices 15, 42, 43, and 47 and allocating the operation to the first operation unit 51, and execution means 57 for executing the operation of the medical device allocated to the first operation unit 51. The selection means 56 and the execution means 57 are controlled based on a difference in the operation information when the pedal operation units 53 and 54 serving as the first operation unit 51 are operated. For example, the operation information includes an operation time length of the first operation unit 51 itself, the number of operations, and a difference in operation positions. However, in the incubator 101, the selection means 56 and the execution means 57 are controlled based on a difference in the operation time information when the pedal operation units 53 and 54 are operated. The counting start switch and the alarm sound stop switch are also displayed on the idle screens 32 (reference numerals 67 and 63) of the display unit 31. The medical devices may be operated by pressing the operation switches 67 and 63 of the idle screen 32 instead of the first operation unit 51.

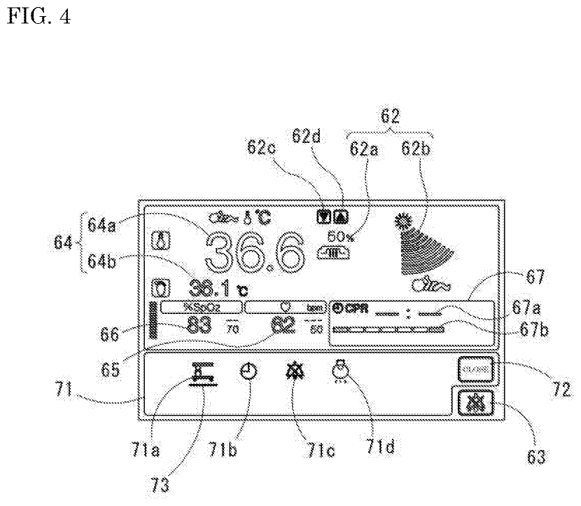

In a normal operation state (idle state) of the incubator 101, the display unit 31 displays the idle screen 32 illustrated in FIG. 3. Therefore, in the idle state, the second operation unit 52 can be operated by using the hand. Then, as illustrated by the flowchart in FIG. 8, in the idle state of the incubator 101, if any one of the pedal operation units 53 and 54 (first operation unit 51) is stepped on and operated by using the foot (pedal operation in Step S11), the control unit 55 proceeds the process from Step S11 to Step S12. In Step S12, the operation time of the pedal operation is confirmed, and it is determined whether the operation time falls within a selected operation time (one second in this case) which is set in advance and stored in the storage unit 49. Then, when the operation time of the pedal operation falls within the selected operation time, the process proceeds from Step S12 to Step S13, and it is confirmed whether the selection screen 71 as illustrated in FIG. 4 is displayed on the display unit 31. In a case where the selection screen 71 is not displayed on the display unit 31, the process proceeds from Step S13 to Step S14, and the selection screen 71 is displayed on the display unit 31. Means for executing processes from Step S11 to Step S14 corresponds to selection screen display means 561 (refer to FIG. 9) for displaying the selection screen according to the present invention, and the process is performed by the control unit 55.

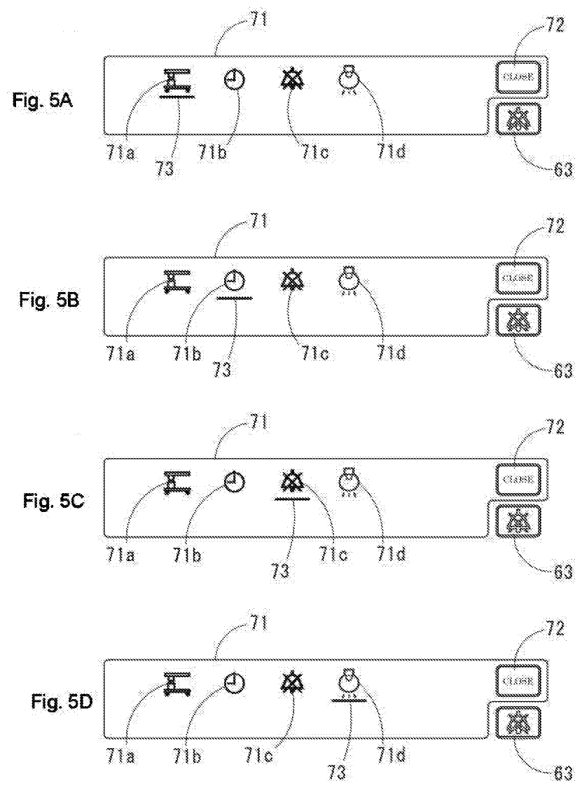

In this case, as illustrated in FIGS. 4 and 5A-5D, the selection screen 71 displays four icons 71a to 71 such as an icon 71a showing the raising-lowering operation switch of the raising-lowering means 15 operable by the first operation unit 51, an icon 71b showing the counting start switch of the resuscitation timer 43, an icon 71c showing the alarm sound stop switch, and an icon 71d showing the on/off switch of the lighting lamp 42. In addition, as illustrated in FIG. 5A to FIG. 5D, a cursor 73 is displayed below any one of the icons 71a to 71d showing the operation which is most recently allocated to the first operation unit 51, and the first operation unit 51 is allocated to the operation of the medical device indicated by the icon selected by the cursor 73. For example, in FIGS. 4 and 5(a), the cursor 73 is displayed below the icon 71a showing the raising-lowering means 15, and FIG. 4 and FIG. 5A illustrate a state where the first operation unit 51 is allocated to the raising-lowering operation switch of the raising-lowering means 15. In Step S14, the first operation unit 51 is in a state of being allocated to the operation switch of the raising-lowering means 15. In this assumption, description will be continued.

Next, the process proceeds again from Step S14 to Step S11, and it is determined whether the pedal operation units 53 and 54 are operated again. Then, when the pedal operation units 53 and 54 are operated, the process proceeds to Step S12. When the pedal operation units 53 and 54 are not operated, the process proceeds to Step S15.

In Step S15, it is determined whether a non-operation time of the pedal operation units 53 and 54 falls within a display release time (3 seconds in this case) which is set in advance and stored in the storage unit 49. That is, when the pedal operation units 53 and 54 are operated within the display release time, the process proceeds to Step S12. When the pedal operation units 53 and 54 are not operated within the display release time (are not operated beyond the display release time), the process proceeds to Step S16. In Step S16, the selection screen 71 of the display unit 31 is erased, and the display screen of the display unit 31 returns to the idle screen 32.

On the other hand, when the pedal operation units 53 and 54 are operated within the display release time in Step S15, the process proceeds to Step S12. Then, in Step S12, the operation time of the pedal operation is confirmed, and it is determined whether the operation time falls within the above-described selected operation time. When the operation time falls within the selected operation time, the process proceeds from Step S12 to Step S13. As illustrated in FIG. 5A, the selection screen 71 is already displayed in the display unit 31, and the first operation unit 51 is in a state of being allocated to the raising-lowering operation switch (icon 71a) of the raising-lowering means 15. Accordingly, the process proceeds from Step S13 to Step S17. In Step S17, the allocation of the first operation unit 51 is switched from the operation (icon 71a) for the raising-lowering operation switch which is already selected to the operation (icon 71b) for the counting start switch of the resuscitation timer 43. As illustrated in FIG. 5B, the cursor 73 is displayed below the icon 71b. Means for executing the processes from Step S11 to Step S17 subsequent to Step S14 corresponds to operation switching means 562 (refer to FIG. 9) for switching the operation of the medical device allocated to the first operation unit 51 according to the present invention, and the process is performed by the control unit 55.

Then, the process proceeds again from Step S17 to Step S11, and it is determined whether the pedal operation units 53 and 54 are operated again. Then, when the pedal operation units 53 and 54 are operated, the process proceeds to Step S12. When the pedal operation units 53 and 54 are not operated, the process proceeds to Step S15. As described above, in Step S15, it is determined whether the non-operation time of the pedal operation units 53 and 54 falls within the display release time (3 seconds in this case). When the pedal operation units 53 and 54 are operated within the display release time, the process proceeds to Step S12. When the pedal operation units 53 and 54 are not operated within the display release time (beyond the display release time), the process proceeds to Step S16.

In this way, in the incubator 101, the pedal operation units 53 and 54 are repeatedly operated within the selected operation time. In this manner, as illustrated in FIG. 5A to FIG. 5D, the operations of the medical devices allocated to the first operation unit 51 can be sequentially switched. In this case, a switching order of the operations of the medical devices can be changed depending on whether to operate any one of the right and left pedal operation units 53 and 54. For example, in a case where the pedal operation unit 53 on the left side is operated, the cursor 73 is moved leftward so that the operations of the respective medical devices are switched counterclockwise. In a case where the pedal operation unit 54 on the right side is operated, the cursor 73 is moved rightward so that the operations of the respective medical devices are switched clockwise.

Next, as illustrated in FIG. 4 and FIG. 5A, the selection screen 71 is already displayed, and in a state where the first operation unit 51 is allocated to the raising-lowering operation switch (icon 71a) of the raising-lowering means 15, when the pedal operation units 53 and 54 are operated for long time beyond the selected operation time, the process proceeds from Step S12 to Steps S21 and S22. In Step S21, the operation of the medical device allocated to the first operation unit 51 is confirmed at the time of the pedal operation. In this case, the selection of the raising-lowering operation switch (icon 71a) of the raising-lowering means 15 is confirmed. Means for executing the processes from Step S11 to Step S21 subsequent to Step S17 corresponds to operation confirmation means 563 (refer to FIG. 9) for confirming the selection of the medical device according to the present invention, and the process is performed by the control unit 55.

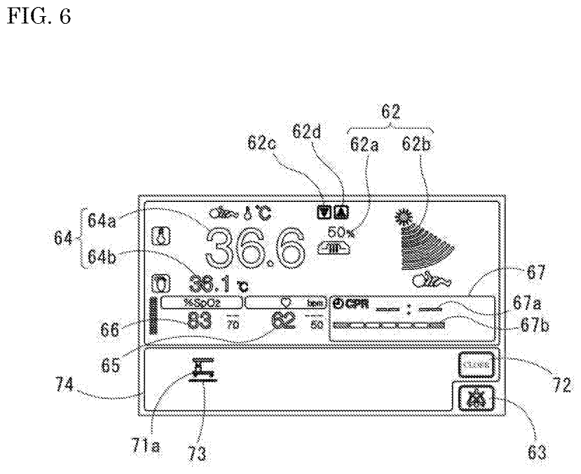

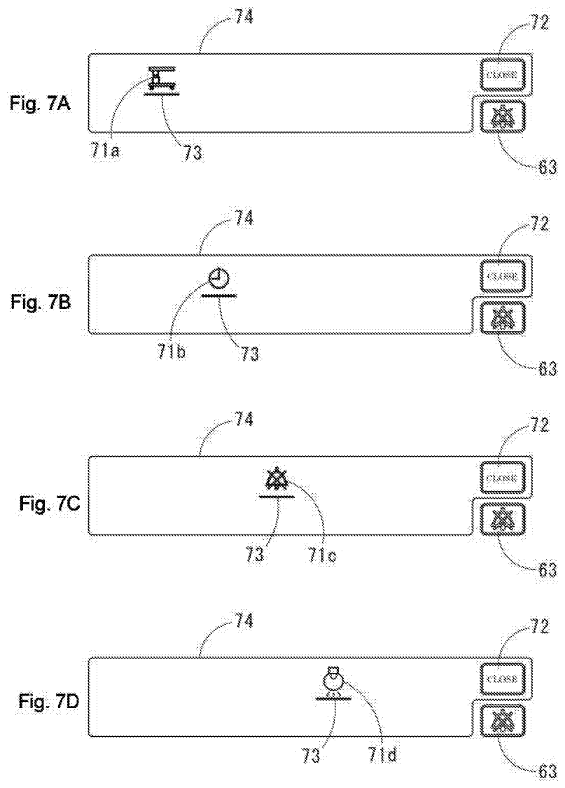

Then, in Step S22, the confirmation screen 74 is displayed on the display unit 31 as illustrated in FIG. 6 and FIG. 7A. The confirmation screen 74 displays only the icon 71a of the raising-lowering means 15 confirmed to be allocated to the first operation unit 51. In a case where the selection of the medical device other than the raising-lowering means 15 is confirmed, any one of the confirmation screens 74 illustrated in FIG. 7B to FIG. 7D is displayed. In addition, as illustrated in FIG. 9, the selection screen display means 561 to the operation confirmation means 563 (the selection screen display means 561, the operation switching means 562, and the operation confirmation means 563) serve as the selection means 56 according to the present invention.

As illustrated in FIG. 6 and FIG. 7A, in a state where the raising-lowering operation switch (icon 71a) of the raising-lowering means 15 is allocated to the first operation unit 51 and the selection is confirmed, when the pedal operation units 53 and 54 are operated, the process proceeds from Step S23 to Steps S24 and S25. In Step S24, the medical device confirmed to be selected is operated. In this case, the selection is confirmed for the raising-lowering operation switch (icon 71a) of the raising-lowering means 15, and the operation of the raising-lowering means 15 is performed (started). Means for executing the processes from Step S23 to Step S24 subsequent to Step S22 corresponds to execution means 57 for executing the operation of the medical device according to the present invention, and the process is performed by the control unit 55.

Specifically, the operator presses the pedal operation unit 53 of the first operation unit 51 by using the foot, thereby moving the base 11 downward. The bed base 12 attached to the base 11 is also moved downward together with the base 11. On the other hand, the operator presses the pedal operation unit 54 by using the foot, thereby moving the base 11 upward. The bed base 12 attached to the base 11 is also moved upward together with the base 11.

Next, the process proceeds again from Step S24 to Step S23, and it is determined whether the pedal operation units 53 and 54 are operated again. Then, when the pedal operation units 53 and 54 are operated, the process proceeds to Step S24. When the pedal operation units 53 and 54 are not operated, the process proceeds to Step S25.

In Step S25, it is determined whether the non-operation time of the pedal operation units 53 and 54 falls within the display release time (3 seconds). That is, when the pedal operation units 53 and 54 are operated within the display release time, the process proceeds to Step S24. When the pedal operation units 53 and 54 are not operated within the display release time (beyond the display release time), the process proceeds to Step S16.

Then, when the pedal operation units 53 and 54 are operated within the display release time in Step S25, the process proceeds to Step S24. As illustrated in FIG. 6 and FIG. 7A, the raising-lowering operation switch (icon 71a) of the raising-lowering means 15 is allocated to the first operation unit 51, thereby maintaining a state where the selection is confirmed. Accordingly, as described above, the operation of the raising-lowering means 15 is performed in Step S24.

In Step S25, when the pedal operation units 53 and 54 are not operated within the display release time, the process proceeds to Step S16. In Step S16, the confirmation screen 74 of the display unit 31 is erased, and the display screen of the display unit 31 returns to the idle screen 32.

As illustrated in FIGS. 4 to 8, in the incubator 101, the selection screen 71 and the confirmation screen 74 display a switch 72 for closing (erasing from the display screen) the screens 71 and 74. Then, when the selection screen 71 or the confirmation screen 74 is displayed on the display unit 31, the switch 72 of the display unit 31 is operated by using the hand. In this manner, even if the operation is performed within the display release time (3 seconds), the selection screen 71 or the confirmation screen 74 is forcibly closed, thereby enabling the idle screen 32 to be displayed. Therefore, the respective medical devices can be operated by operating the operation switches of the idle screen 32.

In addition, in the above-described incubator 101, the medical devices allocated to the first operation unit 51 are operated by the four switches such as the raising-lowering operation switch of the raising-lowering means 15, the counting start switch of the resuscitation timer 43, the alarm sound stop switch of the alarm device 47, and the on/off switch of the lighting lamp 42. However, the operations of the medical devices allocated to the first operation unit 51 are not limited to the four operations. A type of the medical devices is not limited to that according to the above-described embodiment. For example, the number of the medical devices allocated to the first operation unit 51 can be 3 or less, or can be 5 or more. Depending on needs of medical workers, the operations of various medical devices can be customized by allocating the operations to the first operation unit 51.

In this way, as the operation unit for operating the medical devices, the incubator 101 according to the present embodiment includes the first operation unit 51 which can be operated by using the location other than the hand, for example, the foot, the knee, and the elbow of the operator. Accordingly, the operator can operate various medical devices without interrupting the medical treatment (while continuously performing the medical treatment). In addition, the operator can easily and visually recognize the operation status of the medical device and the patient information by using the display unit 31. Accordingly, even the first operation unit 51 is operated using the location other than the hand, the operator can easily operate the medical device while accurately recognizing the operation status of the medical device and the patient information. Furthermore, the operator can select various medical devices by operating the first operation unit 51 itself, and can perform the operation. Without using both hands, that is, without touching the first operation unit 51, the first operation unit 51 enables the operator to operate various medical devices. Accordingly, it is possible to prevent cross infection to the patient which is caused by the operations.

In addition, as in the incubator 101 according to the present embodiment, each operation of the respective medical devices is allocated to the first operation unit 51 disposed in one location. Therefore, it is not necessary to dispose a plurality of operation units for each of the medical devices, and thus, a configuration of the incubator 101 can be simplified. In addition, each of the medical devices can be operated only by operating the first operation unit 51 disposed in one location. Therefore, the operator can easily operate the medical devices. Furthermore, the medical device allocated to the first operation unit can be easily confirmed in the display unit 31 by the operator. Therefore, it is possible to avoid a risk such as an operation error.

In addition, according to the incubator 101, the pedal operation units 53 and 54 which can be operated by using the foot away from the hand are adopted as the first operation unit, and the first operation unit 51 can be operated by using the foot. In this manner, compared to a case where the first operation unit 51 is operated by using the elbow close to the hand, the movement of both hands of the operator during the operation of the first operation unit 51 can be less affected. Therefore, the operator can easily and reliably operate various medical devices even during the medical treatment.

In addition, according to the incubator 101, in addition to the first operation unit 51, a configuration including the second operation unit 52 which can be operated by using the hand of the operator is adopted. Accordingly, the incubator 101 can also be operated by means which is the same as that in the related art. Therefore, it is possible to improve operability of the operator.

The present invention is not limited to the above-described embodiment, and various modifications can be made within the scope not departing from the gist of the present invention.

For example, in the incubator 101 according to the above-described embodiment, the first operation unit 51 is configured to include the pedal operation units 53 and 54. However, the first operation unit 51 is not limited to this configuration. The first operation unit 51 may be configured to include the operation unit which can be operated, for example, by using the knee or the elbow in addition to the location other than the hand and the foot of the operator. For example, a configuration may be adopted as follows. A button operable by being pressed with the elbow is disposed on the lower side surface of the base 11 or the bed base 12 so as to function as the first operation unit. Alternatively, a button operable by being pressed with the knee is disposed on in the upper support pillar 13 so as to function as the first operation unit. The first operation unit is operated by using the knee, the elbow, and the leg other than the hand. Accordingly, it is preferable to dispose the first operation unit at a position lower than a shoulder height position located when the operator stands around the incubator 101. In this way, the first operation unit which can be operated by using the location other than the hand is provided. Therefore, the operator can operate various medical devices without interrupting the medical treatment (while continuously performing the medical treatment).

In addition, according to the above-described embodiment, when the first operation unit is operated within the selected operation time set in advance, the selection screen for allocating any one operation of the plurality of medical devices to the first operation unit is displayed on the selection screen display means. However, a configuration may be adopted as follows. After a state of operating the second operation unit is continuously maintained, when the first operation unit is operated regardless of whether or not the operation is performed within the selected operation time, the selection screen display means is displayed. Alternatively, the selection screen display means may always display the selection screen together with the idle screen.

In addition, the medical device operable using the first operation unit or the medical device operable using the second operation unit is not limited to the configuration according to the embodiment. If necessary, the medical device may be appropriately used as a target. Furthermore, a configuration may be adopted as follows. All of the medical devices operable using the first operation unit may be operated using the second operation unit. Alternatively, some of the medical devices operable using the first operation unit may be specified so that the medical devices can be operated using the second operation unit.

### INDUSTRIAL APPLICABILITY

This invention can be used as an incubator used for medical treatment of a patient such as a newborn baby.

What is claimed is:

1. An incubator comprising:
an operation unit that enables an operator to operate a plurality of medical devices;
a control unit that manages the medical devices and the operation unit; and
a display unit capable of displaying each operation status of the medical devices and patient information,
wherein the operation unit includes a first operation unit which is operable by using a location other than a hand of the operator,
wherein the control unit includes selection means for selecting an operation of any one medical device from the plurality of medical devices so as to allocate the medical device to the first operation unit, and execution means for executing an operation of the medical device allocated to the first operation unit,
wherein the selection means includes:
selection screen display means for causing the display unit to display a selection screen for allocating any operation of the plurality of medical devices to the first operation unit,
operation switching means for switching the operation of the medical device allocated to the first operation unit, when the first operation unit is repeatedly operated within a selected operation time subsequently to the display of the selection screen, and
operation confirmation means for confirming the selection of the medical device allocated at an operation time thereof, when the first operation unit is operated beyond the selected operation time in a state where any one operation of the medical devices is allocated to the first operation unit, and
wherein the execution means executes the operation of the medical device selected at an operation time thereof, when the first operation unit is operated in a state where the selection of the medical device is confirmed.

2. The incubator according to claim 1,
wherein the selection screen display means causes the display unit to display the selection screen, when the first operation unit is operated within the selected operation time.

3. The incubator according to claim 1,
wherein the first operation unit is a pedal operation unit which is operable by using a foot of the operator.

4. The incubator according to claim 1,
wherein the operation unit includes a second operation unit which is operable by using the hand of the operator.

5. The incubator according to claim 4,
wherein the second operation unit is disposed at a position adjacent to the display unit.

6. The incubator according to claim 4,
wherein the display unit is a touch panel-type display unit, and the second operation unit is configured to be shared with the display unit.
